(19) United States
(12) Patent Application Publication
(10) Pub. No.: US 2015/0348664 A1
(43) Pub. Date: Dec. 3, 2015

(54) COPPER ALLOY FOR ELECTRONIC AND ELECTRIC DEVICES, COMPONENT FOR ELECTRONIC AND ELECTRIC DEVICES, AND TERMINAL

(71) Applicant: MITSUBISHI MATERIALS CORPORATION, Tokyo (JP)

(72) Inventors: Hirotaka MATSUNAGA, Okegawa-shi (JP); Kazunari MAKI, Saitama-shi (JP)

(73) Assignee: MITSUBISHI MATERIALS CORPORATION, Tokyo (JP)

(21) Appl. No.: 14/653,568

(22) PCT Filed: Dec. 20, 2013
(86) PCT No.: PCT/JP2013/084251

§ 371 Date: Jun. 18, 2015

(30) Foreign Application Priority Data
Jan. 9, 2013 (JP) 2013-001941

(51) Int. Cl. H01B 1/02; C22C 9/00

(52) U.S. Cl. CPC H01B 1/026; C22C 9/00

(57) ABSTRACT

A copper alloy for electronic and electric devices has a composition in which the amount of Zr is in a range of 0.05% by mass to 0.15% by mass, the amount of Ca is in a range of 0.001% by mass to less than 0.08% by mass, the amount of Pb is less than 0.05% by mass, the amount of Bi is less than 0.01% by mass, and the balance Cu and inevitable impurities, the ratio Zr/Ca of the amount of Zr to the amount of Ca is 1.2 or more, the copper alloy includes two-phase particles made up of two phases of a phase containing Cu and Zr as main components and a phase containing Cu and Ca as main components and single-phase particles made of a single phase containing Cu and Zr as main components, and the conductivity is more than 88% IACS.

### CROSS-REFERENCE TO RELATED PATENT APPLICATIONS

This application is a U.S. National Phase Application under 35 U.S.C. §371 of International Patent Application No. PCT/JP2013/084251, filed Dec. 20, 2013, and claims the benefit of Japanese Patent Application No. 2013-001941, filed Jan. 9, 2013, all of which are incorporated by reference in their entirety herein. The International Application was published in Japanese on Jul. 17, 2014 as International Publication No. WO/2014/109211 under PCT Article 21(2).

### FIELD OF THE INVENTION

The present invention relates to a copper alloy for electronic and electric devices, a component for electronic and electric devices and a terminal using the same, the copper alloy being used as a component for electronic and electric devices such as connectors in semiconductor devices, other terminals, movable contacts of an electromagnetic relays, and lead frames.

### BACKGROUND OF THE INVENTION

In the related art, since the above-described component for electronic and electric devices has been required to have different characteristics depending on operation environments, a variety of copper alloys have been used depending on individual applications.

Components for electronic and electric devices such as terminals including connectors, relays, and lead frames are manufactured by, for example, carrying out press punching and then, if necessary, bending and the like on a copper alloy plate. Therefore, the above-described copper alloy is also required to have favorable shearing workability and the like in order to suppress the abrasion of a press mold and the generation of burrs during the press punching and the like. Therefore, copper alloys having improved shearing workability have been thus far proposed as described in, for example, Patent Document 1 to 3.

For example, Patent Document 1 discloses that shearing workability is improved by adding elements such as Pb, Bi, Ca, Sr, Ba, and Te to a variety of copper alloys.

In addition, Patent Document 2 discloses that, in Cu—Cr—Si—Zn—Sn-based alloys, shearing workability is improved by dispersing precipitates having a predetermined size.

Furthermore, Patent Document 3 discloses that, in Cu—Fe—P-based alloys, shearing workability is improved by adding elements such as Mg, Si, Cr, Ti, Zr, and Al and dispersing oxide particles thereof.

### PRIOR ART DOCUMENT

### Patent Document

[Patent Document 1] Japanese Unexamined Patent Application, First Publication No. H10-195562

[Patent Document 2] Japanese Unexamined Patent Application, First Publication No. 2005-113180

[Patent Document 3] Japanese Unexamined Patent Application, First Publication No. 2006-200014

### Technical Problem

For the above-described component for electronic and electric devices, in the case of use requiring a particularly high conductivity, CDA alloy No. C15100 (Cu—Zr-based alloy) is used. The Cu—Zr-based alloy is a precipitation hardening-type copper alloy, has an improved strength while maintaining a high conductivity of approximately 90% IACS, and, furthermore, also has excellent heat resistance.

However, the Cu—Zr-based alloy has a composition of almost pure copper in order to ensure high conductivity, has high ductility, and does not have favorable shearing workability. In detail, when the Cu—Zr-based alloy is subjected to press punching, there is a problem in that burrs are generated and it is not possible to carry out punching with a favorable dimensional accuracy. Furthermore, when the Cu—Zr-based alloy is used, there is another problem in that a mold is abraded or that punching debris are generated.

In recent years, in response to the size reduction of electronic devices, electric devices, and the like, an attempt has been made to reduce the sizes and thicknesses of components for electronic and electric devices, such as terminals including connectors, relays and lead frames used in electronic and electric devices. Therefore, from the viewpoint of making electronic and electric components with a favorable dimensional accuracy, there is a demand for a copper alloy having further improved shearing workability as a material constituting electronic and electric components.

As disclosed by Patent Document 1, in the Cu—Zr-based alloy, shearing workability cannot be sufficiently improved while a high conductivity is maintained only by adding elements such as Pb, Bi, Ca, Sr, Ba, and Te to the alloy. In addition, the elements such as Pb, Bi, and Te are low-melting-point metals and thus there is a concern that hot workability may significantly deteriorate.

In addition, the method disclosed by Patent Document 2 relates to a Cu—Cr—Si—Zn—Sn-based alloy, and even when this method is applied with no modification to the Cu—Zr-based alloy, which belongs to a different alloy system, it is not possible to improve shearing workability.

Furthermore, although it is possible to consider that shearing workability can be improved by dispersing oxide particles as disclosed by Patent Document 3, in a case in which coarse oxide particles are involved, there is a concern that troubles such as breakage or cracking may occur in the subsequent steps.

As described above, in the related art, it is not possible to improve shearing workability while maintaining hot workability or cold workability and conductivity in the above-described Cu—Zr-based alloy.

The present invention has been made in consideration of the above-described circumstances and an object of the present invention is to provide a Cu—Zr-based alloy for electronic and electric devices, which has excellent shearing workability as well as a particularly high conductivity; and a terminal and a component for electronic and electric device which are made of the copper alloy. The Cu—Zr-based alloy is suitable for electronic and electric component such as a terminal including a connector, relays or the like.

### SUMMARY OF THE INVENTION

### Solution to Problem

As a result of thorough studies to solve the above-described problems, the present inventors found that when a small amount of Ca is added to a Cu—Zr-based alloy and the manufacturing conditions are optimized, two-phase particles made of Cu, Zr, and Ca are dispersed in a matrix, and thus it is possible to significantly improve shearing workability while maintaining a high conductivity.

The present invention has been made on the basis of the above-described finding. And a copper alloy for electronic and electric devices of the present invention comprises 0.05% by mass to 0.15% by mass of Zr, 0.001% by mass to less than 0.08% by mass of Ca, less than 0.05% by mass of Pb, less than 0.01% by mass of Bi, and the balance Cu and inevitable impurities, wherein a ratio Zr/Ca of the amount (% by mass) of Zr to the amount (% by mass) of Ca is 1.2 or more, the copper alloy includes two-phase particles made up of two phases of a phase containing Cu and Zr as main components and a phase containing Cu and Ca as main components and single-phase particles made of a single phase containing Cu and Zr as main components, and the conductivity is more than 88% IACS.

According to the copper alloy for electronic and electric devices having the above-described constitution, since the copper alloy includes the two-phase particles made up of two phases of a phase containing Cu and Zr as main components and a phase containing Cu and Ca as main components, when shearing working represented by press punching or the like is carried out on the copper alloy, the two-phase particles serve as the starting points of fracture and shearing workability is significantly improved.

In addition, since the single-phase particles made of a single phase containing Cu and Zr as main components are precipitated, strength can be improved through precipitation hardening and it also becomes possible to improve shearing workability.

Since the amount of Zr is 0.05% by mass or more, it is possible to sufficiently disperse the above-described two-phase particles and single-phase particles and shearing workability and strength can be improved. On the other hand, since the amount of Zr is 0.15% by mass or less, it is possible to suppress a decrease in conductivity and precipitates can be uniformly dispersed by reliably forming a solution of Zr. In order to reliably exhibit the above-described effects, the amount of Zr is preferably in a range of 0.06% by mass to 0.14% by mass.

In addition, since the amount of Ca is 0.001% by mass or more, it is possible to reliably disperse the above-described two-phase particles and shearing workability can be improved. On the other hand, since the amount of Ca is less than 0.08% by mass, workability can be ensured and it is possible to limit the occurrence of troubles such as breakage or cracking in hot working and cold working after casting. In order to reliably exhibit the above-described effects, the amount of Ca is preferably in a range of 0.002% by mass to 0.03% by mass.

Furthermore, since the ratio Zr/Ca of the amount (% by mass) of Zr to the amount (% by mass) of Ca is 1.2 or more, it is possible to reliably disperse the two-phase particles made up of two phases of a phase containing Cu and Zr as main components and a phase containing Cu and Ca as main components and single-phase particles made of a single phase containing Cu and Zr as main components.

In addition, since the amount of Pb is less than 0.05% by mass (500 ppm) and the amount of Bi is less than 0.01% by mass (100 ppm), it is possible to suppress a decrease in grain boundary strength due to the segregation of Pb and Bi which are low-melting-point metals and hot workability can be improved.

In order to reliably exhibit the above-described effects, the amounts of Pb and Bi are preferably 0.001% by mass (10 ppm) or less and more preferably 0.0005% by mass (5 ppm) or less.

Furthermore, since the conductivity is more than 88% IACS, the above-described single-phase particles are sufficiently precipitated in the matrix and it becomes possible to reliably improve strength. In addition, it is possible to use the copper alloy as a material for electronic and electric components requiring a particularly high conductivity. In order to reliably exhibit the above-described effects, the conductivity is preferably 89% IACS or more and more preferably 90% IACS or more.

In the copper alloy for electronic and electric devices of the present invention, the two-phase particles are preferably made up of a phase made of an intermetallic compound having a crystal structure of Cu₅Zr or Cu₅₁Zr₁₄ and a phase made of an intermetallic compound having a crystal structure of Cu₅Ca.

In this case, since the two-phase particles are precipitated in the matrix of Cu in a casting step and the two-phase particles remain in Cu even after the subsequent working step, it becomes possible to reliably improve shearing workability.

In addition, in the copper alloy for electronic and electric devices of the present invention, the amount of S is preferably 0.0005% by mass or less and the amount of 0 is preferably 0.0003% by mass or less.

Since S reacts with Zr and Ca so as to form sulfides and O reacts with Zr and Ca so as to form oxides, Zr and Ca are consumed. Therefore, when the amounts of S and O are regulated as described above, it is possible to secure the Zr and Ca necessary to form the two-phase particles and the single-phase particles and to reliably improve shearing workability and strength.

A component for electronic and electric devices and a terminal of the present invention are made of the above-described copper alloy for electronic and electric devices.

Since components for electronic and electric devices (for example, terminals such as connectors or the like, relays, and lead frames) having the above-described constitution, particularly terminals such as connectors or the like, have excellent conductivity, strength, and shearing workability, dimensional accuracy is excellent and it is possible to exhibit excellent characteristics even when the sizes and thicknesses of the components are reduced.

### Advantageous Effects of Invention

According to the present invention, it is possible to provide a copper alloy for electronic and electric devices which has excellent shearing workability as well as a particularly high conductivity and is made of a Cu—Zr-based alloy suitable for electronic and electric components such as terminals including connectors and relays; and a component for electronic and electric devices and a terminal which are made of the copper alloy for electronic and electric devices.

### BRIEF DESCRIPTION OF THE DRAWINGS

FIG. 1 is a flowchart showing an example of steps for a copper alloy for electronic and electric devices which is an embodiment of the present invention.

FIG. 2 is an explanatory view of a ratio of a rupture surface which evaluates shearing workability in Examples.

FIG. 3 is a TEM observation picture of two-phase particles in Example 4.

FIG. 4A is a TEM observation picture of single-phase particles in Example 4.

FIG. 4B is an EDX analysis result of single-phase particles in Example 4.

### DETAILED DESCRIPTION OF THE INVENTION

Hereinafter, a copper alloy for electronic and electric devices which is an embodiment of the present invention will be described.

The copper alloy for electronic and electric devices which is the present embodiment has a composition in which the amount of Zr is in a range of 0.05% by mass to 0.15% by mass, the amount of Ca is in a range of 0.001% by mass to less than 0.08% by mass, the amount of Pb is less than 0.05% by mass, the amount of Bi is less than 0.01% by mass, and the balance Cu and inevitable impurities, and the ratio Zr/Ca of the amount (% by mass) of Zr to the amount (% by mass) of Ca is 1.2 or more. Furthermore, in the present embodiment, the amount of S is regulated to 0.0005% by mass or less and the amount of 0 is regulated to 0.0003% by mass or less. In addition, in the copper alloy for electronic and electric devices which is the present embodiment, the conductivity is more than 88% IACS.

In addition, the copper alloy for electronic and electric devices which is the present embodiment includes single-phase particles made of a single phase containing Cu and Zr as main components and two-phase particles made up of two phases of a phase containing Cu and Zr as main components and a phase containing Cu and Ca as main components. The “main components” in the single-phase particles and the two-phase particles refer to a component of which the content is the largest and a component of which the content is having the second largest. For example, in the single phase constituting the single-phase particles, Cu and Zr correspond to the components of which the content is the largest and the second largest.

In the present embodiment, the above-described two-phase particles are made up of a phase made of an intermetallic compound having a crystal structure of Cu₅Zr or Cu₅₁Zr₁₄ and a phase made of an intermetallic compound having a crystal structure of Cu₅Ca.

Hereinafter, the reasons for regulating the amounts, conductivities, and structures of the above-described elements as described above will be described.

(Zr: 0.05% by mass or more and 0.15% by mass or less)

Zr bonds with Cu so as to form the above-described single-phase particles and be thus precipitated in a Cu matrix and is an element having an effect that improves strength. In addition, Zr is an element that forms the above-described two-phase particles and has an effect that improves shearing workability when added to Cu together with Ca.

When the amount of Zr is less than 0.05% by mass, it is not possible to sufficiently exhibit the effect. On the other hand, when the amount of Zr exceeds 0.15% by mass, there is a concern that conductivity may significantly decrease.

For the above-described reasons, the amount of Zr is in a range of 0.05% by mass to 0.15% by mass. Since Zr is an active element, when Zr forms oxides, sulfides, or the like and is involved as inclusions, there is a concern that defects such as breakage or cracking in the subsequent workings may be caused. From the viewpoint of preventing the above-described defects, the amount of Zr is preferably in a range of 0.06% by mass to 0.14% by mass.

(Ca: 0.001% by mass or more and less than 0.08% by mass)

Ca is an element that forms the above-described two-phase particles when added to Cu together with Zr and has an effect that improve shearing workability.

When the amount of Ca is less than 0.001% by mass, it is not possible to sufficiently exhibit the effect. On the other hand, when the amount of Ca is 0.08% by mass or more, there is a concern that breakage or cracking may occur in hot and cold working after casting.

For the above-described reasons, the amount of Ca is in a range of 0.001% by mass to less than 0.08% by mass. In order to reliably disperse the second-phase particles and ensure workability after casting, the amount of Ca is preferably in a range of 0.002% by mass to 0.03% by mass.

(Zr/Ca: 1.2 or more)

As described above, since the addition of Zr and Ca to Cu forms the two-phase particles, when the amount of Zr is relatively smaller than that of Ca, the single-phase particles containing Cu and Zr as the main components cannot be formed and there is a concern that strength cannot be improved through precipitation hardening.

For the above-described reasons, in the present embodiment, the ratio Zr/Ca of the amount (% by mass) of Zr to the amount (% by mass) of Ca is 1.2 or more.

(Pb: less than 0.05% by mass Bi: less than 0.01% by mass)

Pb and Bi are elements that are segregated at grain boundaries and the like as low-melting-point metals and significantly deteriorate hot workability.

Therefore, in the present embodiment, the amount of Pb is regulated to less than 0.05% by mass and the amount of Bi is regulated to less than 0.01% by mass, whereby hot workability is ensured. In order to reliably prevent the deterioration of hot workability, the amounts of Pb and Bi are preferably 0.001% by mass or less and more preferably 0.0005% by mass or less.

(S: less than 0.0005% by mass O: less than 0.0003% by mass)

S is an element that reacts with Zr and Ca so as to form sulfides. In addition, O is an element that reacts with Zr and Ca so as to form oxides. Therefore, when a great amount of S and O are present, Zr and Ca are consumed in forms of sulfides and oxides, the above-described two-phase particles and single-phase particles become insufficient and there is a concern that shearing workability and strength cannot be improved.

Therefore, in the present embodiment, the amount of S is regulated to less than 0.0005% by mass and the amount of O is regulated to less than 0.0003% by mass.

In addition, examples of the inevitable impurities include Mg, Sn, Fe, Co, Al, Ag, Mn, B, P, Sr, Ba, Sc, Y, rare earth elements, Hf, V, Nb, Ta, Cr, Mo, W, Re, Ru, Os, Se, Te, Rh, Ir, Pd, Pt, Au, Zn, Cd, Ga, In, Li, Si, Ge, As, Sb, Ti, Tl, C, Ni, Be, N, H, and Hg. The total amount of these inevitable impurities is desirably 0.3% by mass or less.

(Two-Phase Particles)

The two-phase particles refer to particles that crystallize in the matrix of Cu in Casting Step S02 described below.

The two-phase particles are made up of two phases of a phase containing Cu and Zr as main components and a phase containing Cu and Ca as main components and, in the present embodiment, are made up of a phase made of an intermetallic compound having a crystal structure of Cu₅Zr or Cu₅₁Zr₁₄ and a phase made of an intermetallic compound having a crystal structure of Cu₅Ca.

The two-phase particles serve as the starting points of fracture during shearing working and thus have an action that improves shearing workability.

(Single-Phase Particles)

The single-phase particles are made of an intermetallic compound containing Cu and Zr as main components. The single-phase particles are obtained by precipitating Zr that is a solid solution in the matrix of Cu and have an action that improves strength while maintaining a high conductivity through precipitation hardening.

(Conductivity: 88% IACS or More)

In a case in which Zr forms a solid solution in the matrix of Cu, conductivity significantly decreases. In the present embodiment, since the conductivity is more than 88% IACS, the above-described single-phase particles are sufficiently precipitated and it is possible to reliably improve strength.

In order to reliably exhibit the above-described effects, the conductivity is preferably 89% IACS or more and more preferably 90% IACS or more.

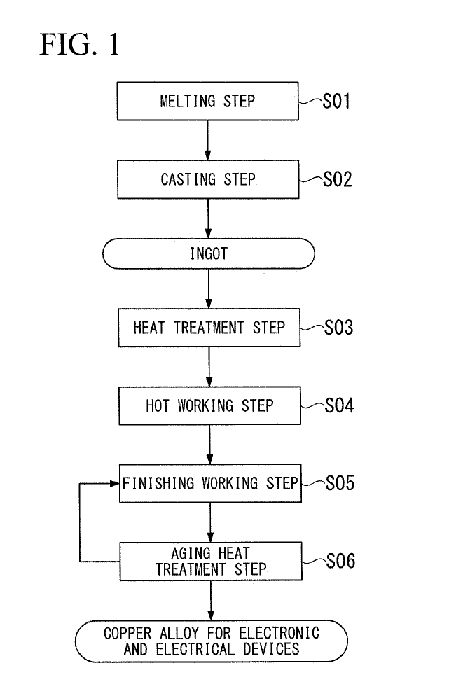

Next, a method for manufacturing the copper alloy for electronic and electric devices, which is the present embodiment, having the above-described constitution will be described with reference to the flowchart shown in FIG. 1.

(Melting Step S01)

First, components were adjusted by adding Zr and Ca to molten copper obtained by melting a copper raw material, thereby producing a molten copper alloy. Meanwhile, in the addition of Zr and Ca, a Zr single body and a Ca single body, a Cu—Zr master alloy and a Cu—Ca master alloy, or the like can be used. In addition, a raw material including Zr and Ca may be melted together with the copper raw material. A recycled material and a scrap material of the present alloy may be used.

As the molten copper, a so-called 4NCu having a purity of 99.99% by mass or more is preferably produced. In the melting step, a vacuum furnace or an atmosphere furnace in which an inert gas atmosphere or a reducing atmosphere is formed is preferably used in order to suppress the oxidization and the like of Zr and Ca which are active elements.

(Casting Step S02)

The molten copper alloy having the adjusted components is injected into a casting mold, thereby producing an ingot. In a case in which mass production is taken into account, continuous casting or semi-continuous casting is preferably used.

In the present embodiment, the cooling rate during solidification is less than 5° C./second and preferably in a range of 0.1° C./second to less than 5° C./second.

Through Casting Step S02, two-phase particles made up of two phases of a phase containing Cu and Zr as main components and a phase containing Cu and Ca as main components crystallize in the matrix of Cu.

(Thermal Treatment Step S03)

Next, a thermal treatment is carried out for homogenizing the obtained ingot and solutionizing thereof. When a thermal treatment of heating the ingot at a temperature in a range of 800° C. to 1080° C. is carried out, Zr is homogeneously diffused or a solid solution of Zr is formed in the matrix in the ingot. Thermal Treatment Step S03 is preferably carried out in a non-oxidizing or reducing atmosphere.

There is no particular limitation regarding a cooling method after the heating and a method such as water quenching, in which the cooling rate is 200° C./min or more, is preferably employed.

In Thermal Treatment Step S03, the two-phase particles that have crystallized in Casting Step S02 do not form a solid solution or diffuse and are maintained unchanged.

(Hot Rolling Step S04)

Next, hot rolling is carried out in order to increase the efficiency of rough working and homogenize the structure. There is no particular limitation regarding the working method; however, in a case in which the final shape is a plate or a strip, rolling is preferably employed. In the case of a line or a rod, extrusion or groove rolling is preferably employed and, in the case of a bulk shape, forging or pressing is preferably employed. The temperature during hot working is also not particularly limited and is preferably in a range of 500° C. to 1050° C.

Meanwhile, there is no particular limitation regarding a cooling method after the hot rolling and a method in which the cooling rate is 200° C./min or more such as water quenching is preferably employed.

In addition, after the hot rolling, intermediate working or an intermediate thermal treatment may be added in order to reliably form a solid solution, form a recrystallization structure, and soften the ingot to improve workability. In the intermediate working step, there is no particular limitation regarding the temperature condition, but the intermediate working is preferably carried out in a range of −200° C. to 200° C. in which cold or warm working is carried out. In addition, regarding the working rate, an appropriate working rate may be selected so as to obtain a shape that approximates the final shape, but the working rate is preferably 20% or more in order to reduce the number of times of the intermediate thermal treatment step until the final shape is obtained. The working rate is more preferably 30% or more. There is no particular limitation regarding a plastic working method and, for example, rolling, wiredrawing, extrusion, groove rolling, forging, pressing, and the like can be employed.

There is no particular limitation regarding the method for the intermediate thermal treatment, but the thermal treatment is preferably carried out in a non-oxidizing atmosphere or a reducing atmosphere under a condition in a range of 500° C. to 1050° C. The intermediate working and the intermediate thermal treatment step may be repeatedly carried out.

(Finishing Working Step S05)

Next, the material that has been subjected to the above-described steps is cut as necessary and, simultaneously, surface grinding is carried out as necessary in order to remove oxidized films and the like formed on the surface. In addition, cold working is carried out at a predetermined working rate. While there is no particular limitation regarding the temperature condition in Finishing Working Step S05, the temperature is preferably in a range of −200° C. to 200° C. In addition, an appropriate working rate may be selected so as to obtain a shape that approximates the final shape, but the working rate is preferably 30% or more in order to improve strength through work hardening and, in a case in which the additional improvement of strength is required, the working rate is more preferably 50% or more. There is no particular limitation regarding the working method; however, in a case in which the final shape is a plate or a strip, rolling is preferably employed. In the case of a line or a rod, extrusion or groove rolling is preferably employed and, in the case of a bulk shape, forging or pressing is preferably employed.

(Aging Thermal Treatment Step S06)

Next, an aging thermal treatment is carried out on the finishing-worked material obtained through Finishing Working Step S05 in order to increase strength and conductivity. Through Aging Thermal Treatment Step S06, single-phase particles made of a single phase containing Cu and Zr as main components are precipitated.

The thermal treatment temperature is not particularly limited, but is preferably in a range of 250° C. to 600° C. in order to uniformly disperse and precipitate single-phase particles having the optimal size.

Finishing Working Step S05 and Aging Thermal Treatment Step S06 may be repeatedly carried out. In addition, in order to improve strength, cold rolling at a working rate in a range of 10% to 70% may be carried out. Furthermore, a thermal treatment may be carried out to thermally refine, obtain stress relaxation resistance, or remove residual stain. Meanwhile, there is no particular limitation regarding a cooling method after the thermal treatment, and a method in which the cooling rate is 200° C./min or more, such as water quenching, is preferably employed.

The copper alloy for electronic and electric devices including two-phase particles made up of two phases of a phase containing Cu and Zr as main components and a phase containing Cu and Ca as main components and single-phase particles made of a single phase containing Cu and Zr as main components is produced.

In addition, when punching working, bending working, and the like are carried out on the copper alloy for electronic and electric devices of the present embodiment as a material, for example, components for electronic and electric devices such as terminal including connectors, relays, and lead frames are formed.

According to the copper alloy for electronic and electric devices of the present embodiment, having the above-described constitution, since the two-phase particles made up of two phases of a phase containing Cu and Zr as main components and a phase containing Cu and Ca as main components crystallize in the matrix of Cu, when shearing working such as press punching is carried out, the two-phase particles serve as the starting points of fracture and shearing workability is significantly improved. As a result, it becomes possible to shape components for small-size electronic and electric devices through press punching or the like with a favorable dimensional accuracy.

In addition, since the single-phase particles made of a single phase containing Cu and Zr as main components are precipitated in the matrix of Cu, it is possible to improve conductivity and strength. In addition, it is also possible to improve shearing workability as well.

In the present embodiment, since the conductivity is more than 88% IACS, the above-described single-phase particles are sufficiently precipitated in the matrix of Cu and it becomes possible to reliably improve strength.

Furthermore, in the present embodiment, since the amount of Zr is in a range of 0.05% by mass to 0.15% by mass, it is possible to improve shearing workability and strength by sufficiently dispersing the above-described two-phase particles and single-phase particles and to limit a decrease in conductivity. As a result, it is possible to obtain copper alloys for electronic and electric devices having high conductivity, high strength, and excellent shearing workability.

In addition, since the amount of Ca is in a range of 0.001% by mass to less than 0.08% by mass, it is possible to reliably disperse the above-described two-phase particles and to improve shearing workability and, furthermore, it is possible to ensure hot workability and cold workability.

Furthermore, since the ratio Zr/Ca of the amount (% by mass) of Zr to the amount (% by mass) of Ca is 1.2 or more, it is possible to reliably precipitate not only the two-phase particles but also the single-phase particles containing Cu and Zr as main components and to improve strength.

In addition, since the amount of Pb is less than 0.05% by mass and the amount of Bi is less than 0.01% by mass, it is possible to ensure hot workability.

Furthermore, since the amount of S is regulated to 0.0005% by mass or less and the amount of O is regulated to 0.0003% by mass or less, it is possible to limit Zr and Ca being consumed in forms of sulfides and oxides and to sufficiently disperse the above-described two-phase particles and single-phase particles.

In addition, in the present embodiment, since the cooling rate during solidification is less than 5° C./second and preferably in a range of 0.1° C./second to less than 5° C./second in Casting Step S02, it is possible to reliably crystallize the above-described two-phase particles in the matrix of Cu and to improve shearing workability.

Furthermore, in the present embodiment, since an aging thermal treatment is carried out at a temperature in a range of 250° C. to 600° C. in Aging Thermal Treatment Step S06, it is possible to uniformly disperse and precipitate fine single-phase particles and to improve strength.

Thus far, the copper alloy for electronic and electric devices which is an embodiment of the present invention has been described, but the present invention is not limited thereto and can be appropriately modified within the scope of the technical idea of the present invention.

For example, in the above-described embodiment, an example of the method for manufacturing the copper alloy for electronic and electric devices has been described, but the manufacturing method is not limited to the present embodiment and the copper alloy may be manufactured by appropriately selecting an existing manufacturing method.

### EXAMPLES

Hereinafter, the results of confirmation experiments carried out to confirm the effects of the present invention will be described.

A copper raw material made of oxygen-free copper (ASTM B152 C10100) having a purity of 99.99% by mass or more was prepared, was loaded into a high-purity graphite crucible, and was melted using a high frequency in an atmosphere furnace in which an Ar gas atmosphere was formed. A variety of additive elements were added to the obtained molten copper so as to prepare a component composition described in Table 1 and the mixture was poured into an insulating material (isowool) casting mold, thereby producing an ingot. The cooling rate during solidification was 1° C./second. In addition, the ingot had a thickness of approximately 20 mm, a width of approximately 20 mm, and a length of approximately 100 mm to 120 mm.

A heating step in which heating was carried out for 4 hours under a temperature condition described in Table 2 was carried out on the obtained ingot in an Ar gas atmosphere in order for homogenizing and solutionizing and then water quenching was carried out.

The thermally-treated ingot was cut and surface grinding was carried out in order to remove oxide films.

After that, hot rolling was carried out at a temperature and a working rate described in Table 2, water quenching was carried out, and then cold rolling was carried out under conditions described in Table 2, thereby producing a strip material having a thickness of approximately 0.5 mm and a width of approximately 20 mm.

In addition, an aging thermal treatment was carried out on the obtained strip material at a temperature described in Table 2 until a predetermined conductivity was obtained, thereby producing a strip material for characteristic evaluation.

(Workability Evaluation)

In order to evaluate workability, the generation of cracked edges during the hot rolling and the cold rolling was observed.

Strip materials from which no or rare cracked edges were visually observed were evaluated to be “A”, strip materials in which small cracked edges having a length of less than 1 mm were generated were evaluated to be “B”, strip materials in which cracked edges having a length in a range of 1 mm to less than 3 mm were generated were evaluated to be “C”, and strip materials in which large cracked edges having a length of 3 mm or more were generated were evaluated to be “D”. The strip materials which were evaluated to be “C” since the lengths of the cracked edges were in a range of 1 mm to less than 3 mm were determined to cause no practical problems.

The length of a cracked edge refers to the length of a cracked edge protruding toward the widthwise center portion from the widthwise edge portion of the rolled material. The evaluation results are described in Table 3.

(Mechanical Characteristics)

A No. 13B test specimen regulated by JIS Z 2201:1998 (corresponding to the current JIS Z 2241:2011; JIS Z 2241:2011 is based on ISO 6892-1:2009) was taken from the strip material for characteristic evaluation and the tensile strength was measured according to JIS Z 2241:2011.

The test specimen was taken so that the tensile direction of a tensile test became parallel to the rolling direction of the strip material for characteristic evaluation. The evaluation results are described in Table 3.

(Conductivity)

A test specimen having a width of 10 mm and a length of 60 mm was taken from the strip material for characteristic evaluation and the electric resistance was obtained using the four-terminal method. In addition, the dimensions of the test specimen were measured using a micrometer and the volume of the test specimen was computed. Furthermore, the conductivity was computed from the measured electric resistance value and the volume. The test specimen was taken so that the lengthwise direction thereof became parallel to the rolling direction of the strip material for characteristic evaluation. The evaluation results are described in Table 3.

(Shearing Workability)

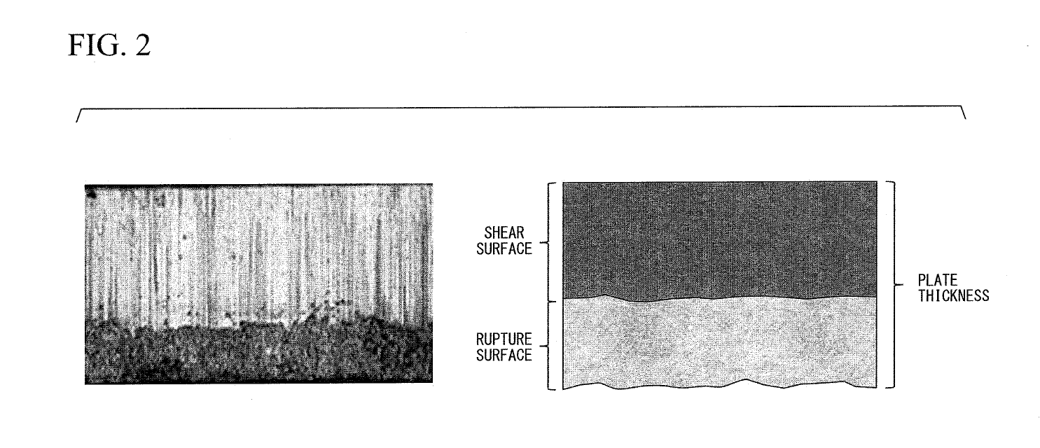

A number of square holes (8 mm×8 mm) were punched out from the strip material for characteristic evaluation by stamping dies and shearing workability was evaluated by measuring the ratio of a rupture surface shown in FIG. 2 (the ratio of a rupture surface in the plate thickness of the punched-out portion) and a burr height. On the cutting plane of punching, a rupture surface and a shearing surface are present and, when the ratio of a shearing surface is smaller and the ratio of a rupture surface is larger, shearing workability becomes more favorable.

The die clearance was 0.02 mm and punching was carried out at a punching rate of 50 spm (stroke per minute). For the measurement of the ratio of the rupture surface and the burr height, the cutting plane surface on a hole-punched side was observed and the average of 10 measurement positions was evaluated. The evaluation results are shown in Table 3.

(Particle Observation)

In order to confirm the generation state of the two-phase particles, observation was carried out in a 1000 time-magnified view (approximately 20000 μm²/view) using a field emission scanning electron microscope (FE-SEM).

Next, in order to investigate the density (particles/μm²) of the two-phase particles, a 1000 time-magnified view (approximately 20000 μm²/view) on which the generation state of the particles was not unique was selected and, in the region thereof, 10 continuous views (approximately 5000 μm²/view) were photographed at a magnification of 2000 times. As the particle diameter, the average value of the long diameter (the length of the longest straight line that could be drawn in a grain under a condition that the straight line did not come into contact with a grain boundary in the middle) and the short diameter (the length of the longest straight line that could be drawn in a direction that intersected the long diameter at right angles under a condition that the straight line did not come into contact with a grain boundary in the middle) was used. In addition, the density (particles/μm²) of the two-phase particles having a particle diameter of 0.1 μm or more was obtained. The evaluation results are described in Table 3.

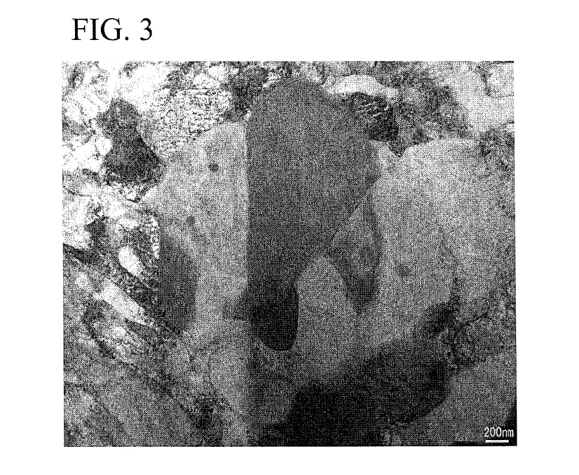

In addition, in order to confirm the crystal structures of the respective phases of the two-phase particles, particles were observed using a transmission electron microscope (TEM: manufactured by Hitachi, Ltd., HF-2000) and an energy-dispersive X-ray (EDX) analysis and an electron beam diffraction analysis were carried out. The observation result of Example 4 is shown in FIG. 3.

As a result of the electron beam diffraction, it was confirmed that the two-phase particles were made up of a phase of an intermetallic compound containing Cu₅Zr (space group F-43m (216)) or Cu₅₁Zr₁₄ (space group P6/m (175)) as main components and a phase of an intermetallic compound containing Cu₅Ca (space group P6/mmm (191)) as a main component.

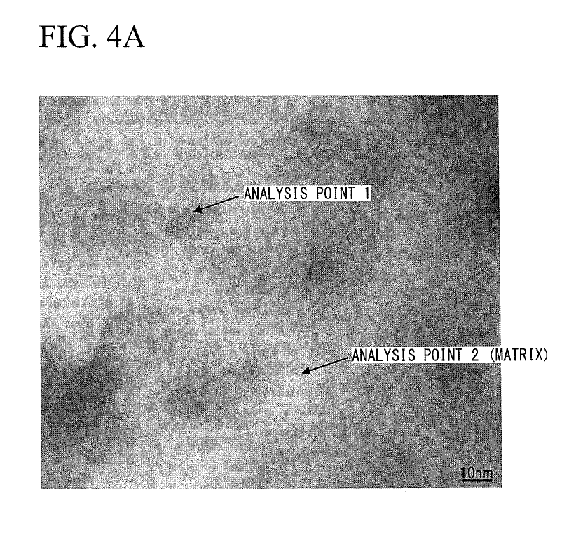

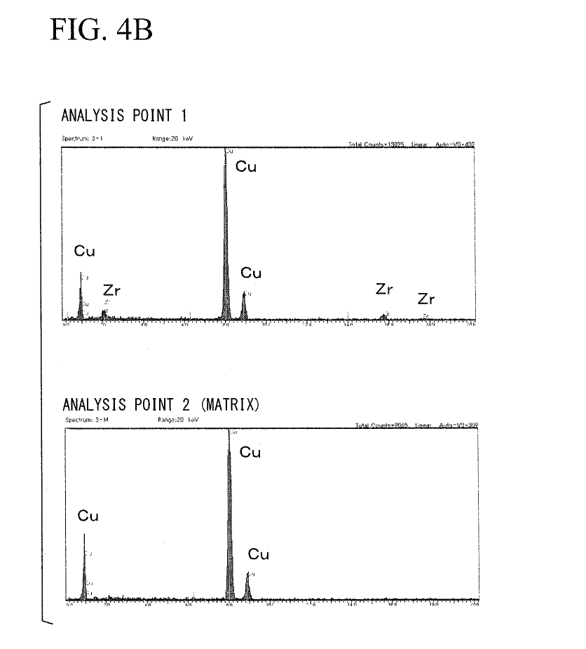

Furthermore, in order to confirm the generation state of the single-phase particles, particles were observed using a TEM and an EDX analysis instrument (manufactured by Kevex Inc., EDX analysis instrument Sigma). Single-phase particles having a particle diameter in a range of 1 nm to 50 nm were observed at a magnification of 750,000 times (the area of the observation view was approximately 2×10⁴ nm²). Furthermore, the composition of the single-phase particles was analyzed through the energy-dispersive X-ray (EDX) analysis. The observation results of Example 4 are described in FIGS. 4A and 4B.

From the results of the EDX analysis, it was confirmed that the single-phase particles that were dispersed and precipitated in the matrix of Cu were particles made up of Cu and Zr.

Meanwhile, in FIGS. 4A and 4B, the analysis point 1 indicates the single-phase particle made of a single phase containing Cu and Zr as main components. At the analysis point 2, the matrix of the copper alloy for electronic and electric devices of Example 4 was analyzed.

TABLE 1

| | | Alloy component composition | | | | | | | |
|---|---|---|---|---|---|---|---|---|---|
| | | Zr % | Ca % | | Pb ppm | Bi ppm | S ppm | O ppm | |
| | | by mass | by mass | Zr/Ca | by mass | by mass | by mass | by mass | Cu |
| Example | 1 | 0.053 | 0.0021 | 25.2 | 3.2 | 3.8 | 2 | 1 | Balance |
| | 2 | 0.098 | 0.0033 | 29.7 | 2.6 | 2.5 | 3 | 2 | Balance |
| | 3 | 0.146 | 0.0033 | 44.2 | 0.7 | 0.6 | 4 | 1 | Balance |
| | 4 | 0.103 | 0.0220 | 4.7 | 2.1 | 2.1 | 1 | 2 | Balance |
| | 5 | 0.143 | 0.0221 | 6.5 | 0.9 | 3.1 | 3 | 2 | Balance |
| | 6 | 0.106 | 0.0764 | 1.4 | 0.8 | 3.4 | 2 | 1 | Balance |
| | 7 | 0.143 | 0.0765 | 1.9 | 0.5 | 3.9 | 2 | 1 | Balance |
| | 8 | 0.052 | 0.0026 | 20.0 | 0.6 | 0.9 | 3 | 1 | Balance |
| | 9 | 0.051 | 0.0010 | 51.0 | 3.2 | 0.6 | 10 | 2 | Balance |
| | 10 | 0.053 | 0.0010 | 53.0 | 2.9 | 1.5 | 3 | 6 | Balance |
| Comparative | 1 | 0.005 | 0.0211 | 0.2 | 0.8 | 0.7 | 4 | 2 | Balance |
| Example | 2 | 0.821 | 0.0231 | 35.6 | 1.2 | 2.7 | 3 | 1 | Balance |
| | 3 | 0.104 | 0.0002 | 520.0 | 1.3 | 3.6 | 2 | 1 | Balance |
| | 4 | 0.143 | 0.5110 | 0.3 | 0.6 | 1.2 | 1 | 2 | Balance |
| | 5 | 0.056 | 0.0030 | 18.7 | 990 | 0.9 | 2 | 2 | Balance |
| | 6 | 0.062 | 0.0034 | 18.2 | 4.2 | 950 | 2 | 2 | Balance |
| | 7 | 0.057 | 0.0024 | 23.8 | 3.3 | 1.2 | 3 | 1 | Balance |

TABLE 2

| | | Steps | | | | | |
|---|---|---|---|---|---|---|---|
| | | Thermal | Hot working | | | Finishing | Aging thermal |
| | | treatment | | Initiation | End | working | treatment |
| | | Temperature | Working | temperature | temperature | Working | Temperature |
| | | (° C.) | rate (%) | (° C.) | (° C.) | rate (%) | (° C.) |
| Example | 1 | 960 | 60 | 900 | 700 | 94 | 400 |
| | 2 | 960 | 60 | 900 | 700 | 94 | 400 |
| | 3 | 960 | 60 | 900 | 700 | 94 | 400 |
| | 4 | 960 | 60 | 900 | 700 | 94 | 400 |
| | 5 | 960 | 60 | 900 | 700 | 94 | 400 |
| | 6 | 960 | 60 | 900 | 700 | 94 | 400 |
| | 7 | 960 | 60 | 900 | 700 | 94 | 400 |
| | 8 | 960 | 60 | 900 | 700 | 94 | 400 |
| | 9 | 960 | 60 | 900 | 700 | 94 | 400 |
| | 10 | 960 | 60 | 900 | 700 | 94 | 400 |
| Comparative | 1 | 960 | 60 | 900 | 700 | 94 | 400 |
| Example | 2 | 960 | 60 | 900 | 700 | 94 | — |
| | 3 | 960 | 60 | 900 | 700 | 94 | 400 |
| | 4 | 960 | 60 | 900 | 700 | 94 | — |
| | 5 | 960 | 60 | 900 | 700 | — | — |
| | 6 | 960 | 60 | 900 | 700 | — | — |
| | 7 | 960 | 60 | 900 | 700 | 94 | 400 |

TABLE 3

| | | Evaluation | | | | | | | |
|---|---|---|---|---|---|---|---|---|---|
| | | | | | | Two-phase particles | | Shearing workability | |
| | | Hot | Cold | | | having particle | | Ratio of | |
| | | working | working | | Presence of | diameter of | Tensile | rupture | Burr |
| | | cracked | cracked | Conductivity | single-phase | 0.1 μm or more | strength | surface | height |
| | | edge | edge | (IACS %) | particles | (particles/10000 μm²) | (MPa) | (%) | (μm) |
| Example | 1 | A | B | 96.4 | Yes | 3 | 422 | 26 | 6 |
| | 2 | A | B | 93.1 | Yes | 4 | 460 | 32 | 7 |
| | 3 | A | B | 91.2 | Yes | 5 | 455 | 32 | 6 |
| | 4 | A | B | 90.8 | Yes | 3 | 465 | 30 | 6 |
| | 5 | A | B | 90.9 | Yes | 6 | 465 | 39 | 4 |
| | 6 | A | C | 90.6 | Yes | 4 | 432 | 41 | 3 |
| | 7 | B | C | 90.5 | Yes | 6 | 468 | 52 | 4 |
| | 8 | A | B | 88.3 | Yes | 2 | 432 | 21 | 8 |
| | 9 | B | A | 92.1 | Yes | 2 | 401 | 19 | 9 |
| | 10 | A | A | 91.8 | Yes | 3 | 405 | 18 | 9 |
| Comparative | 1 | A | A | 96.2 | No | 0 | 200 | 3 | 15 |
| Example | 2 | B | D | — | — | — | — | — | — |
| | 3 | B | A | 92.8 | Yes | 0 | 452 | 5 | 16 |
| | 4 | B | D | — | — | — | — | — | — |
| | 5 | D | — | — | — | — | — | — | — |
| | 6 | D | — | — | — | — | — | — | — |
| | 7 | A | A | 84.4 | Yes | 2 | 290 | 9 | 12 |

In Comparative Example 1 in which the amount of Zr was below the range of the present invention, it was confirmed that two-phase particles having a particle diameter of 0.1 μm or more were rarely present, the ratio of the rupture surface was small, the burr height also became high, and the shearing workability was poor. In addition, the strength was also insufficient.

In Comparative Example 3 in which the amount of Ca was below the range of the present invention, it was confirmed that two-phase particles having a particle diameter of 0.1 μm or more were rarely present, the ratio of the rupture surface was small, the burr height also became high, and the shearing workability was poor.

In addition, in Comparative Examples 2 and 4 in which the amounts of Zr and Ca were above the range of the present invention, large cracked edges were generated during cold rolling, which made the working difficult, and thus the production was stopped. It was confirmed that the cold workability deteriorated.

In Comparative Examples 5 and 6 in which the amounts of Pb and Bi were above the range of the present invention, cracking occurred during hot working, which made the working difficult, and thus the production was stopped.

In Comparative Example 7 in which the conductivity was below the range of the present invention, the strength was insufficient.

In contrast to the above-described comparative examples, in all Examples 1 to 10, large cracked edges of 3 mm or more were not generated during both hot working and cold working and hot workability and cold workability were ensured. In addition, in all the examples, it was confirmed that two-phase particles having a particle diameter of 0.1 μm or more were present, the ratio of the rupture surface was high, and the burr height also became low, and the shearing workability improved.

From what has been described above, it has been confirmed that, according to the Examples including the two-phase particles made up of two phases of a phase containing Cu and Zr as main components and a phase containing Cu and Ca as main components and a single phase containing Cu and Zr as main components, it is possible to provide a copper alloy for electronic and electric devices which has high strength, high conductivity, and excellent shearing workability and is suitable for electronic and electric components.

### INDUSTRIAL APPLICABILITY

Since the copper alloy for electronic and electric devices of the present invention has excellent conductivity, strength, and shearing workability, it is possible to provide a component for electronic and electric devices and a terminal which have excellent dimensional accuracy and exhibit excellent characteristics even when the sizes and thicknesses thereof are reduced. In addition, according to the component for electronic and electric devices and the terminal of the present invention, it is possible to reduce the size and weight of electronic and electric devices.

1. A copper alloy for electronic and electric devices comprising:
0.05% by mass to 0.15% by mass of Zr, 0.001% by mass to less than 0.08% by mass of Ca, less than 0.05% by mass of Pb, less than 0.01% by mass of Bi, and the balance Cu and inevitable impurities,
wherein, a ratio Zr/Ca of the amount (% by mass) of Zr to the amount (% by mass) of Ca is 1.2 or more,
the copper alloy includes two-phase particles made up of two phases of a phase containing Cu and Zr as main components and a phase containing Cu and Ca as main components and single-phase particles made of a single phase containing Cu and Zr as main components, and
a conductivity is more than 88% IACS.

2. The copper alloy for electronic and electric devices according to claim 1,
wherein the two-phase particles are made up of a phase made of an intermetallic compound having a crystal structure of Cu₅Zr or Cu₅₁Zr₁₄ and a phase made of an intermetallic compound having a crystal structure of Cu₅Ca.

3. The copper alloy for electronic and electric devices according to claim 1,
wherein an amount of S is 0.0005% by mass or less and an amount of O is 0.0003% by mass or less.

4. A component for electronic and electric devices made of the copper alloy for electronic and electric devices according to claim 1.

5. A terminal made of the copper alloy for electronic and electric devices according to claim 1.

6. The copper alloy for electronic and electric devices according to claim 2,
wherein an amount of S is 0.0005% by mass or less and an amount of O is 0.0003% by mass or less.

7. A component for electronic and electric devices made of the copper alloy for electronic and electric devices according to claim 2.

8. A component for electronic and electric devices made of the copper alloy for electronic and electric devices according to claim 3.

9. A terminal made of the copper alloy for electronic and electric devices according to claim 2.

10. A terminal made of the copper alloy for electronic and electric devices according to claim 3.

11. A component for electronic and electric devices made of the copper alloy for electronic and electric devices according to claim 6.

12. A terminal made of the copper alloy for electronic and electric devices according to claim 6.
